(19) United States
(12) Patent Application Publication
(10) Pub. No.: US 2015/0017614 A1
(43) Pub. Date: Jan. 15, 2015

(54) METHOD OF MANAGING FUEL INTAKE IN INDIVIDUALS TO ENHANCE ATHLETIC PERFORMANCE

(71) Applicant: PEPSICO, INC., Purchase, NY (US)

(72) Inventors: Kimberley Stein, Chicago, IL (US); Melissa Tippet, Purchase, NY (US)

(21) Appl. No.: 14/379,056

(22) PCT Filed: Feb. 15, 2013
(86) PCT No.: PCT/US13/26475

§ 371 Date: Aug. 15, 2014

Related U.S. Application Data
(60) Provisional application No. 61/600,199, filed on Feb. 17, 2012.

(51) Int. Cl. G09B 19/00

(52) U.S. Cl. CPC G09B 19/0092
USPC 434/127

(57) ABSTRACT

A method for assisting individuals with managing their fuel consumption at different points throughout athletic training or competitions is provided, which includes collecting information about the individual participating in the athletic event in addition to information about the event itself, providing feedback to the individual based on this information, monitoring the individual's energy level at the moment of sweat and using this information to tailor a fueling plan for the individual. In one aspect, the individual may provide her information and access her customized fueling plan using a web-based browser or a mobile device application.

### CROSS REFERENCE TO RELATED APPLICATIONS

This application claims the benefit of U.S. Provisional Application No. 61/600,199, filed Feb. 17, 2012, the entire disclosure of which is hereby incorporated by reference.

### FIELD

The present disclosure relates to a method to assist individuals with managing their fuel consumption at different points throughout training or competition to achieve enhanced athletic performance.

### BACKGROUND

In preparing for competitions and participating in athletic activity or an athletic event, the vast majority of individuals are unaware of the types and amounts of fuel necessary for consumption in order to enhance or optimize athletic performance. Individuals need the right fuels at the right times to support training or performance goals for athletic events. Hence, individuals need to train their bodies to accept fuels at specific times in order to maximize performance. Existing methods or systems of monitoring consumption only track nutrition, which does not directly correlate to fuel intake for exercise and athletic performance purposes. Thus, a need exists in the field for a method, grounded in sports science and sports nutrition, to assist individuals with managing their fuel consumption at different points during training and competition.

### SUMMARY

The present disclosure relates to a method for managing fuel intake specifically designed for individuals training for and participating in athletic events. In particular, the present disclosure relates to: assessing the type of activity, time of performance, duration of the activity, intensity of the event, goals set for the event, and the type of athlete participating in the event; arriving at a plan or schedule for consuming certain fuel; providing instruction to the individual for consumption of foods identified according to the fuel schedule; and assessing the individual's feedback, in particular, his or her energy level at the moment of sweat, in order to better instruct the individual regarding fueling needs. In another aspect, the method may be provided electronically, such as via the internet or via an application for a mobile device carried by the athlete during the activity.

### BRIEF DESCRIPTION OF THE DRAWINGS

FIG. 1 illustrates an illustrative network architecture and fuel plan server that may be utilized in accordance with an aspect of the disclosure.

FIG. 2 is a flowchart of an example computer-implemented method of managing fuel intake during an event in accordance with one embodiment.

### DETAILED DESCRIPTION

The instant disclosure is directed to a method for managing fuel intake during training for and competing in athletic events. The instant disclosure provides a method for the individual to provide feedback about his energy levels at the moment of sweat following receipt of specific information relating to the individual. The instant aspect uses this information in conjunction with the type, intensity and duration of the athletic even to generate a fueling plan for the individual. The method as set forth in more detail below assists the individual athlete with training his or her body to accept fuels at the appropriate times in order to enhance and maximize his performance in the particular athletic event. The method generates a fueling plan based on the type of athletic activity and the time of day that the individual will train or compete.

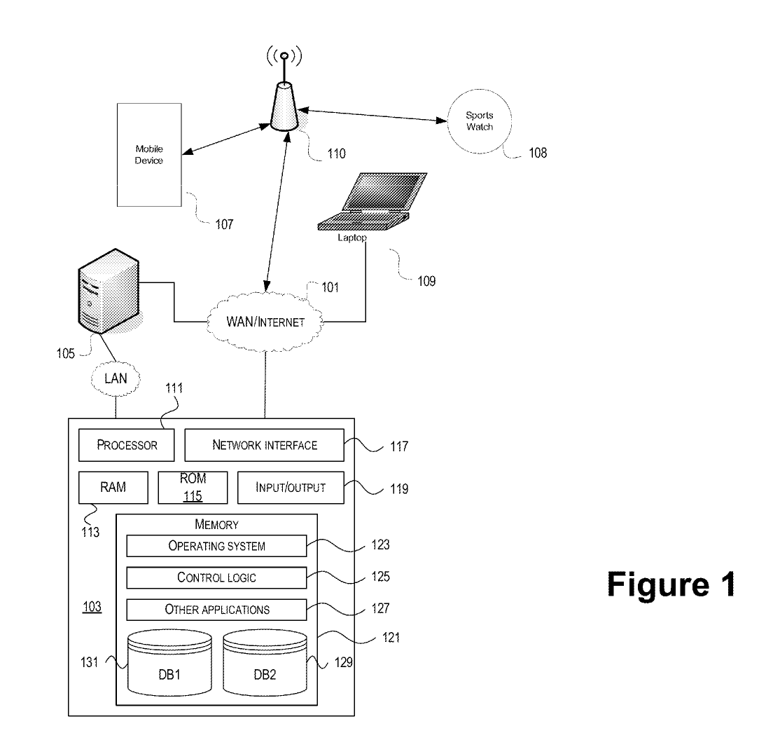

FIG. 1 illustrates one example of a network architecture and fuel plan processing device that may be used to implement one or more illustrative aspects of the disclosure. Various network nodes 103, 105, and 109 may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (such as sports watch 108 and/or other devices not shown) may be connected to one or more of the networks via twisted pair wires, coaxial cable, fiber optics, radio waves or other communication media. In an embodiment, the devices may include a tablet or other touch screen computing device.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which may reside across all physical networks.

The components may include fuel plan server 103, dietary information server 105, mobile device 107, sports watch 108, and/or user computer 109. In one embodiment, fuel plan server 103 may provide overall access, control and administration of one or more collections of data (e.g., databases) and control software for performing one or more illustrative aspects of the disclosure as described herein. In one embodiment, fuel plan server 103 may be connected to dietary information server 105 through which users interact with and obtain data as requested. Alternatively, fuel plan server 103 may act as a dietary information server itself and be directly connected to the Internet. Fuel plan server 103 may be connected to dietary information server 105 through the network 101 (e.g., the Internet), via direct or indirect connection, or via some other network. Users may interact with the fuel plan server 103 using remote computer 109, e.g., using a web browser to connect to the fuel plan server 103 via one or more externally exposed web sites hosted by dietary information server 105. In addition, users may interact with fuel plan server 103 via a sports watch 108 or a mobile device 107. Such devices may be used in concert with fuel plan server 103 to access data stored therein, or may be used for other purposes. For example, from device 109 a user may access dietary information server 105 using an Internet browser, as is known in the art, or by executing a computer-executable instructions on a non-transitory computer-readable medium that communicates with dietary information server 105 and/or fuel plan server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and processing devices used may vary, and are secondary to the functionality that they provide, as further described herein. For example, services provided by dietary information server 105 and fuel plan server 103 may be combined on a single server.

One or more of components 103, 105, 107, 108 and 109 may be any type of known computer, server, or data processing device. Looking to the example fuel plan server 103, it may include a processor 111 controlling overall operation of the fuel plan server 103. Fuel plan server 103 may further include RAM 113, ROM 115, memory 121 and/or any one or more non-transitory computer-readable mediums. As one example, memory 121 may further store operating system software 123 for controlling overall operation of the fuel plan server 103, control logic 125 for instructing fuel plan server 103 to perform aspects of the disclosure as described herein, and other application software 127 providing secondary support, and/or other functionality which may or may not be used in conjunction with aspects of the present disclosure. The control logic may also be referred to herein as the fuel plan server software 125. Functionality of the fuel plan server software may refer to operations or decisions made automatically based on rules coded into the control logic, made manually by a user providing input into the system, and/or a combination of automatic processing based on user input (e.g., queries, data updates, etc.). Those skilled in the art will realize that components 105, 107, 108 and 109 may also include similar hardware components (e.g., processor, RAM/ROM, memory, etc.) as discussed above with respect to fuel plan server 103.

Fuel plan sever 103 may further include network interface 117 and/or input/output interfaces 119 (e.g., keyboard, mouse, display, printer, etc.). I/O 119 may include a variety of interface units and drives for reading, writing, displaying, and/or printing data or files. Memory 121 may also store data used in performance of one or more aspects of the disclosure, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects of the disclosure may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

In one aspect of the instant disclosure, the individual chooses the type of workout/sport/activity (which may include any cardiovascular or strength training activity, including without limitation ball sports, track and field, running, aerobics, yoga, swimming, weight training, etc.), the time or times of day that she will compete, and information regarding the duration of activity, intensity (measured as number of calories burned per hour), the type or level of athlete (professional, elite, serious age group, fitness, recreational, beginner), and the person's overall objective or goal (performance, weight loss, health/fitness, muscle gain, recovery, recreation). For example, the method supports selections such as morning practices, evening competitions two athletic events a day, etc. The information provided by the athlete is evaluated and a fueling plan is generated. The fueling plan instructs individuals on how to choose the right fuels at the right time in preparation for or participating in an athletic event, and identifies food selection choices that relate to the specific fuels. For example, identified foods may include a bagel with cream cheese or certain fruit or other such food items, each of which relate to a specifically identified fuel type (complex carbohydrate, protein, simple carbohydrate, etc.) and an identified amount of each such fuel. In one aspect of the disclosure, this information is compiled in relation to pre-event, during event and post-event fuel needs. Individuals log their feedback and/or progress on each day they train or compete, including tracking and identifying the type and number of fuels consumed, and that information is used to generate a fuel score for the day. Specifically, the feedback includes collecting information from the individual regarding his feelings of energy during the event and on each day of the training or competition events. In particular, the individual logs his feelings of energy during the moment of sweat—i.e., the moment when the individual begins to sweat. In a form of the disclosure, the fuel score is set or may be adjusted on several criteria, preferably including the individual's responses relating to his or her energy level on a regular day of training and on a regular day of competition, coupled with the amount of fuel consumed for the particular day. In one form of the method, individuals receive feedback in the form of a report including a graph to view their fuel score over time, as well as his or her energy ratings. “Athletic event” or “athletic activity” as used herein shall be any type of training or competitive event relating to any sporting activity. Thus, according to one aspect, the athletic events included in the fuel plan may include cross training exercise as well as training that is specific to a particular competitive athletic activity, whereby an aspect of the fuel plan includes a report compiling all athletic activity over a given period of time. In another aspect, the fuel score may be segregated into scoring for different activity, such as training separate from competition events.

In another embodiment, various sensors may collect information regarding the individual and transmit such information to fuel plan server 103. The sensor may include various biological and activity sensors.

The method of the instant disclosure may include at least two integrated levels. The first level comprises gathering information and performing calculations to generate a plan that identifies in detail which fuel nutrients (e.g., carbohydrates, proteins and electrolytes) the individual should consume and at what times. However, this level does not identify specific types of carbohydrates or proteins or amounts of carbohydrates or proteins. Accordingly, the information generated from the first level comprises the nutrients (including carbohydrate energy, fluid, protein and electrolytes) the individual needs to consume in preparing for and participating in the athletic event.

In another aspect of the instant application, the second level of the system or method comprises generating information that may be provided to the individual regarding specific types and amounts of the nutrients identified in level one, including without limitation the specific types of carbohydrates selected from the group consisting of glucose, fructose, sucrose, maltodextrin and others, that should be consumed at specific times before, during and after the specified athletic event.

In one aspect of the instant disclosure, the individual may utilize the second level only after he or she completes the first level. In an alternative aspect of the instant application, such as if the individual has used the method before, or if the individual has experience with fueling in preparation for athletic events, he or she may begin the method at the second level. In one aspect, a third level may also be generated and used by the individual to provide more detail of the fuel plan and reporting of the individual's fuel efficiency. This level optionally may be accessible to the individual after he or she completes the first and/or second level or becomes proficient with the use of the second level to manage fuel intake and efficiency. In level three, the method includes providing the individuals with an overall nutrition plan for health and performance which will incorporate appropriate fueling information.

Examples of several aspects of the instant application follow:

### Example 1

The following is an example of a fueling plan relating to a sprint or high intensity athletic event:

Athletic Event Taking Place in the Morning

| | Timing in | | |
|---|---|---|---|
| | relation to | | |
| | athletic | | |
| Occasion | activity | Patterns | Food Suggestions |
| 01 | ~15 min | Fluid and carbohydrate | Juice, sweetened gelatin product |
| | before | energy | |
| 02 | During | Fluid, carbohydrate energy | A sports drink with sugar and sodium |
| | | and electrolytes (primarily | is your best option. You can also use |
| | | sodium) | gel or chew products with water. |
| 03 | Within | Carbohydrate energy, | Bagel with egg white, scrambled egg |
| | 30 min | protein, electrolytes | whites and toast, pancakes or cereal, |
| | after | (primarily sodium), and | low-fat cottage cheese and fruit, |
| | | fluid | Greek yogurt |

Athletic Event Taking Place Mid-Day

| | Timing in | | |
|---|---|---|---|
| | relation | | |
| | to athletic | | |
| Occasion | activity | Patterns | Food Suggestions |
| 01 | Breakfast | Meal (⅔ carbohydrate, | Bagel with egg, fruit, fruit juice, cereal, |
| | (3-4 h | lean protein, low fat) and | toast with peanut butter, pancakes |
| | before) | fluid | |
| | ~15 min | Carbohydrate energy | Juice, sweetened gelatin product |
| | before | | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein, and electrolytes | cheese and fruit, pretzels and low-fat |
| | | (primarily sodium) | string cheese, Greek yogurt |

Athletic Event Taking Place in the Afternoon/Evening

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, |
| | (before) | lean protein, low fat) and | cereal, toast with peanut butter, |
| | | fluid | pancake |
| | 3-4 h | Meal (⅔ carbohydrate, | Grilled chicken with pasta or baked |
| | before | lean protein, low fat) and | potato, lean meat sandwich with |
| | | fluid | pretzels, rice and beans |
| | ~15 min | Carbohydrate energy | Juice, sweetened gelatin product |
| | before | | |
| 02 | During | Carbohydrate energy, fluid | A sports drink with sugar and sodium |
| | | and electrolytes (primarily | is your best option. You can also use |
| | | salt) | gel or chew products with water. |
| 03 | Within 30 min | Carbohydrate energy, | Lean meat sandwich, low-fat cottage |
| | after | protein, fluid, and | cheese and fruit, pretzels and low-fat |
| | | electrolytes (primarily | string cheese, Greek yogurt |
| | | salt) | |

### Example 2

The following is an example of a fueling plan relating to a strength training athletic event:

Athletic Event Taking Place in the Morning

| | Timing in | | |
|---|---|---|---|
| | relation | | |
| | to athletic | | |
| Occasion | activity | Patterns | Food Suggestions |
| 01 | ~15 min | Fluid and carbohydrate | Juice, sweetened gelatin product |
| | before | energy | |
| 02 | During | Carbohydrate energy, fluid | A sports drink with sugar and sodium is |
| | | and electrolytes (primarily | your best option. You can also use gel |
| | | salt) | or chew products with water. |
| 03 | Within 30 min | Carbohydrate energy, | Bagel with egg white, scrambled egg |
| | after | protein, electrolytes | whites and toast, pancakes or cereal, |
| | | (primarily salt), and fluid | low-fat cottage cheese and fruit, Greek |
| | | | yogurt |
| | 2 hours | Meal (⅔ carbohydrate, | Smoothie made with fruit and Greek |
| | after | lean protien, low fat) and | yogurt, lean meat sandwich, pretzels |
| | | fluid | and low-fat string cheese |

Athletic Event Taking Place in Mid-Day

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, |
| | (3-4 h | lean protein, low fat) and | cereal, toast with peanut butter, |
| | before) | fluid | pancakes |
| | ~15 min | Carbohydrate energy | Juice, sweetened gelatin product |
| | before | | |
| 02 | During | Carbohydrate energy, | A sports drink with sugar and sodium |
| | | fluid and electrolytes | is your best option. You can also use |
| | | (primarily salt) | gel or chew products with water. |
| 03 | Within 30 min | Carbohydrate energy, | Lean meat sandwich, low-fat cottage |
| | after | protein and electrolytes | cheese and fruit, pretzels and low-fat |
| | | (primarily salt) | string cheese, Greek yogurt |
| | 2 hours | Meal (⅔ carbohydrate, | Lean meat sandwich, pasta with lean |
| | after | lean protein, low fat) and | meat sauce, chicken burrito with rice |
| | | fluid | |

Athletic Event Taking Place in the Afternoon/Evening

| | Timing in | | |
|---|---|---|---|
| | relation | | |
| | to athletic | | |
| Occasion | activity | Patterns | Food Suggestions |
| 01 | Breakfast | Meal (⅔ carbohydtae, | Bagel with egg, fruit, fruit juice, cereal, |
| | (before) | lean protien, low fat) and | toast with peanut butter, pancake |
| | | fluid | |
| | 3-4 h | Meal (⅔ carbohydrate, | Grilled chicken with pasta or baked |
| | before | lean protien, low fat) and | potato, lean meat sandwich with |
| | | fluid | pretzels, rice and beans |
| | ~15 min | Carbohydrate energy | Juice, sweetened gelatin product |
| | before | | |
| 02 | During | Carbohydrate energy, fluid | A sports drink with sugar and sodium is |
| | | and electrolytes (primarily | your best option. You can also use gel |
| | | salt) | or chew products with water. |
| 03 | Within 30 min | Carbohydrate energy, | Lean meat sandwich, low-fat cottage |
| | after | protein, fluid and | cheese and fruit, pretzels and low-fat |
| | | electrolytes (primarily salt) | string cheese, Greek yogurt |

Athletic Event Taking Place in the Afternoon/Evening

| | Timing in | | |
|---|---|---|---|
| | relation | | |
| | to athletic | | |
| Occasion | activity | Patterns | Food Suggestions |
| | 2 hours | Meal ( 2/3 carbohydate, | Lean meat sandwich, pasta with lean |
| | after | lean protein, low fat) and | meat sauce, chicken burrito with rice, |
| | | fluid | baked potato with lean steak or pork |
| | | | chop |

### Example 3

The following is an example of a fueling plan relating to a team athletic event:

Athletic Event Taking Place in the Morning (In Season)

| | Timing in | | |
|---|---|---|---|
| | relation | | |
| | to athletic | | |
| Occasion | activity | Patterns | Food Suggestions |
| 01 | ~15 min | Fluid and carbohydrate | Juice, sweetened gelatin product |
| | before | energy | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Bagel with egg white, scrambled egg |
| | after | protein, electrolytes | whites and toast, pancakes or cereal, |
| | | (primarily sodium), and | low-fat cottage cheese and fruit, Greek |
| | | fluid | yogurt |

Athletic Event Taking Place Mid-Day (In Season)

| | Timing in | | |
|---|---|---|---|
| | relation | | |
| | to athletic | | |
| Occasion | activity | Patterns | Food Suggestions |
| 01 | Breakfast | Meal (⅔ carbohydrate, | Bagel with egg, fruit, fruit juice, cereal, |
| | (3-4 h | lean protein, low fat) and | toast with peanut butter, pancake |
| | before) | fluid | |
| | 1-2 h | Fluid and carbohydrate | Fruit, fruit smoothie, pretzels, plain |
| | before | energy | bagel |
| | ~15 min | Carbohydrate energy | Juice, sweetened gelatin product |
| | before | | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein and electrolytes | cheese and fruit, pretzels and low-fat |
| | | (primarily sodium) | string cheese, Greek yogurt or eat your |
| | | | lunch with a blend of carbohydrate and |
| | | | lean protein in this timeframe |

Athletic Event Taking Place in the Afternoon/Evening (In Season)

| | Timing in | | |
|---|---|---|---|
| | relation | | |
| | to athletic | | |
| Occasion | activity | Patterns | Food Suggestions |
| 01 | Breakfast | Meal (⅔ carbohydrate, | Bagel with egg, fruit, fruit juice, cereal, |
| | (before) | lean protien, low fat) and | toast with peanut butter, pancake |
| | | fluid | |
| | 3-4 h | Meal (⅔ carbohydrate, | Grilled chicken with pasta or baked |
| | before | lean protien, low fat) and | potato, Lean meat sandwich with |
| | | fluid | pretzels, rice and beans |
| | 1-2 h | Fluid and carbohydrate | Fruit, fruit smoothie, pretzels, plain |
| | before | energy | bagel |
| | ~15 min | Carbohydrate energy | Juice, sweetened gelatin product |
| | before | | |

Athletic Event Taking Place in the Afternoon/Evening (In Season)

| | Timing in | | |
|---|---|---|---|
| | relation | | |
| | to athletic | | |
| Occasion | activity | Patterns | Food Suggestions |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein, fluid and | cheese and fruit, pretzels and low-fat |
| | | electrolytes (primarily | string cheese, Greek yogurt, or eat your |
| | | sodium) | dinner with a blend of carbohydrate |
| | | | and lean protein in this timeframe |

Athletic Event Taking Place in the Morning (Off-Season)

| | Timing in | | |
|---|---|---|---|
| | relation to | | |
| | athletic | | |
| Occasion | activity | Patterns | Food Suggestions |
| 01 | ~15 min | Fluid and carbohydrate | Juice, sweetened gelatin product |
| | before | energy | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Bagel with egg white, scrambled egg |
| | after | protein, electrolytes | whites and toast, pancakes or cereal, |
| | | (primarily sodium), and | low-fat cottage cheese and fruit, Greek |
| | | fluid | yogurt |
| | 2 hours | Meal (⅔ carbohydrate, | Lean meat sandwich, pasta with lean |
| | after | lean protien, low fat) and | meat sauce chicken burrito with rice, |
| | | fluid | |

Athletic Event Taking Place Mid-Day (Off-Season)

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, cereal, |
| | (3-4 h | lean protein, low fat) and | toast with peanut butter, pancake |
| | before) | fluid | |
| | ~15 min | Carbohydrate energy | Juice, sweetened gelatin product |
| | before | | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein and electrolytes | cheese and fruit, pretzels and low-fat |
| | | (primarily sodium) | string cheese, Greek yogurt or eat your |
| | | | lunch with a blend of carbohydrate and |
| | | | lean protein in this timeframe |
| | 2 hours | Meal (⅔ carbonhydrate, | Pretzels with string cheese, smoothie |
| | after | lean protein, low fat) and | made with Greek yogurt and fruit, lean |
| | | fluid | meat sandwich, pasta with lean meat |
| | | | sauce, chicken burrito with rice |

Athletic Event Taking Place in the Afternoon/Evening (Off-Season)

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, cereal, |
| | (before) | lean protein, low fat) and | toast with peanut butter, pancake |
| | | fluid | |
| | 3-4 h | Meal (⅔ carbohydrate, | Grilled chicken with pasta or baked |
| | before | lean protein, low fat) and | potato, Lean meat sandwich with |
| | | fluid | pretzels, rice and beans |
| | ~15 min | Carbohydrate energy | Juice, sweetened gelatin product |
| | before | | |
| 02 | During | Carbohydrate energy, fluid | A sports drink with sugar and sodium is |
| | | and electrolytes (primarily | your best option. You can also use gel |
| | | sodium) | or chew products with water. |

Athletic Event Taking Place in the Afternoon/Evening (Off-Season)

| | Timing in | | |
|---|---|---|---|
| | relation to | | |
| | athletic | | |
| Occasion | activity | Patterns | Food Suggestions |
| 03 | Within 30 min | Carbohydrate energy, | Lean meat sandwich, low-fat cottage |
| | after | protein, fluid and | cheese and fruit, pretzels and low-fat |
| | | electrolytes (primarily | string cheese, Greek yogurt |
| | | sodium) | |
| | 2 hours | Meal (⅔ carbohydrate, | Pretzels with string cheese, smoothie |
| | after | lean protein, low fat) and | made with Greek yogurt and fruit, lean |
| | | fluid | meat sandwich, pasta with lean meat |
| | | | sauce, chicken burrito with rice |

### Example 4

The following is an example of a fueling plan relating to an endurance athletic event:

Athletic Event Taking Place in the Morning (Training)

| | Timing in | | |
|---|---|---|---|
| | relation to | | |
| | athletic | | |
| Occasion | activity | Patterns | Food Suggestions |
| 01 | ~15 min | Fluid and carbohydrate | Juice, sweetened gelatin product |
| | before | energy | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Greek yogurt, bagel with egg white, |
| | after | protein, electrolyres | scrambled egg whites and toast, |
| | | (primarily sodium) and | pancakes or cereal, low-fat cottage |
| | | fluid | cheese and fruit |

Athletic Event Taking Place Mid-Day (Training)

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, cereal, |
| | (3-4 h | lean protein, low fat) and | toast with peanut butter, pancake |
| | before) | fluid | |
| | 1-2 h | Fluid and carbohydrate | Fruit, fruit smoothie, pretzels, plain |
| | before | energy | bagel |
| | ~15 min | Carbohydrate energy | Juice, sweetened gelatin product |
| | before | | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein and electrolytes | cheese and fruit, pretzels and low-fat |
| | | (primarily sodium) | string cheese, Greek yogurt, or eat your |
| | | | dinner with a blend of carbohydrate |
| | | | and lean protein in this timeframe |

Athletic Event Taking Place in the Afternoon/Evening (Training)

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, cereal, |
| | (before) | lean protein, low fat) and | toast with peanut butter, pancake |
| | | fluid | |
| | 3-4 h | Meal (⅔ carbohydrate, | Grilled chicken with pasta or baked |
| | before | lean protein, low fat) and | potato, lean meat sandwich with |
| | | fluid | pretzels, rice and beans |
| | 1-2 h | Fluid and carbohydrate | Fruit, fruit smoothie, pretzels, plain |
| | before | energy | bagel |
| | ~15 min | Carbohydrate energy | Juice, sweetened gelatin product |
| | before | | |

Athletic Event Taking Place in the Afternoon/Evening (Training)

| | Timing in | | |
|---|---|---|---|
| | relation to | | |
| | athletic | | |
| Occasion | activity | Patterns | Food Suggestions |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein, fluid and | cheese and fruit, pretzels and low-fat |
| | | electrolytes (primarily | string cheese, Greek yogurt, or eat your |
| | | sodium) | dinner with a blend of carbohydrate |
| | | | and lean protein in this timeframe |

Athletic Event Taking Place in the Morning (Race Day)

| | Timing in | | |
|---|---|---|---|
| | relation to | | |
| | athletic | | |
| Occasion | activity | Patterns | Food Suggestions |
| 01 | 1-2 h | Fluid and carbohydrate | Fruit, fruit smoothie, pretzels, plain |
| | before | energy | bagel |
| | ~15 min | Fluid and carbohydrate | Juice, sweetened gelatin product |
| | before | energy | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein, electrolytes | cheese and fruit, pretzels and low-fat |
| | | (primarily sodium) and | string cheese, Greek yogurt, or eat your |
| | | fluid | lunch with a blend of carbohydrate and |
| | | | lean protein in this timeframe |

### Example 5

The following is an example of the fueling plan relating to cardio or cross-training athletic events:

Athletic Event Taking Place in the Morning

| | Timing in | | |
|---|---|---|---|
| | relation to | | |
| | athletic | | |
| Occasion | activity | Patterns | Food Suggestions |
| 01 | ~15 min | Fluid and carbohydrate | Juice, sweetened gelatin product |
| | before | energy | |
| 02 | During | Carbohydrate energy, fluid, | A sports drink with sugar and sodium is |
| | | and electrolytes (primarily | your best option. You can also use gel |
| | | sodium) | or chew products with water. |
| 03 | Within 30 min | Carbohydrate energy, | Bagel with egg white, scrambled egg |
| | after | protein, electrolytes | whites and toast, pancakes or cereal, |
| | | (primarily sodium), fluid | low-fat cottage cheese and fruit, Greek |
| | | | yogurt |

Athletic Event Taking Place Mid-Day

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, cereal, |
| | (3-4 h | lean protein, low fat) and | toast with peanut butter, pancake |
| | before) | fluid | |
| | 1-2 h | Fluid and carbohydrate | Fruit, fruit smoothie, pretzels, plain |
| | before | energy | bagel |
| | ~15 min | Carbohydrate energy | Juice, sweetened gelatin product |
| | before | | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein and electrolytes | cheese and fruit, pretzels and low-fat |
| | | (primarily sodium) | string cheese, Greek yogurt, or eat |
| | | | your lunch with a blend of |
| | | | carbohydrate and lean protein in this |
| | | | timeframe |

Athletic Event Taking Place in the Afternoon/Evening

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, cereal, |
| | (before) | lean protein, low fat) and | toast with peanut butter, pancake |
| | | fluid | |
| | 3-4 h | Meal (⅔ carbohydrate, | Grilled chicken with pasta or baked |
| | before | lean protein, low fat) and | potato, lean meat sandwich with |
| | | fluid | pretzels, rice and beans |
| | 1-2 h | Fluid and carbohydrate | Fruit, fruit smoothie, pretzels, plain |
| | before | energy | bagel |
| | ~15 min | Carbohydrate energy | Juice, sweetened gelatin product |
| | before | | |
| 02 | During | Carbohydrate energy, fluid | A sports drink with sugar and sodium is |
| | | and electrolytes (primarily | your best option. You can also use gel |
| | | sodium) | or chew products with water. |
| 03 | Within 30 min | Carbohydrate energy, | Lean meat sandwich, low-fat cottage |
| | after | protein, fluid and | cheese and fruit, pretzels and low-fat |
| | | electrolytes (primarily | string cheese, Greek yogurt, or eat your |
| | | sodium) | dinner with a blend of carbohydrate |
| | | | and lean protein in this timeframe |

### Example 6

The following is an example of a fueling plan relating to two-a-day training athletic events:

Athletic Event Taking Place in the Morning

| | Timing in | | |
|---|---|---|---|
| | relation to | | |
| | athletic | | |
| Occasion | activity | Patterns | Food Suggestions |
| 01 | ~15 min | Fluid and carbohydrate | Juice, sweetened gelatin product, |
| | before | energy | gummy bears |
| 02 | During | Carbohydrate energy, fluid | A sports drink with sugar and sodium |
| | | and electrolytes (primarily | is your best option. You can also use |
| | | sodium) | gel or chew products with water. |

Athletic Event Taking Place in the Morning

| | Timing in | | |
|---|---|---|---|
| | relation to | | |
| | athletic | | |
| Occasion | activity | Patterns | Food Suggestions |
| 03 | Within 30 min | Carbohydrate energy, | Milk, Greek yogurt, bagel with egg |
| | after | protein, electrolytes | white, scrambled egg whites and toast, |
| | | (primarily sodium) and | pancakes or cereal, low-fat cottage |
| | | fluid | cheese and fruit |

Break between training sessions

| | | | |
|---|---|---|---|
| 01 | ~15 min | Carbohydrate energy | Juice, sweetened gelatin product |
| | before | | |
| 02 | During | Carbonhydrate energy, | A sports drink with sugar and sodium |
| | | fluid and electrolytes | is your best option. You can also use |
| | | (primarily sodium) | gel or chew products with water. |
| 03 | Within 30 min | Carbohydrate energy, | Lean meat sandwich, low-fat cottage |
| | after | protein, fluid and | cheese and fruit, pretzels and low-fat |
| | | electrolytes (primarily | string cheese, Greek yogurt, or eat |
| | | sodium) | your dinner with a blend of |
| | | | carbohydrate and lean protein in this |
| | | | timeframe |

Athletic Event Taking Place in the Afternoon/Evening

| | Timing in | | |
|---|---|---|---|
| | relation to | | |
| | athletic | | |
| Occasion | activity | Patterns | Food Suggestions |
| 01 | Breakfast | Meal (⅔ carbohydrate, | Bagel with egg, fruit, fruit juice, |
| | (before) | lean protein, low fat) and | cereal, toast with peanut butter, |
| | | fluid | pancake |
| | 3-4 h | Meal (⅔ carbohydrate, | Grilled chicken with pasta or baked |
| | before | lean protein, low fat) and | potato, Lean meat sandwich with |
| | | fluid | pretzels, rice and beans |
| | 1-2 h | Fluid and carbohydrate | Fruit, fruit smoothie, pretzels, plain |
| | before | energy | bagel |
| | ~15 min | Carbohydrate energy | Juice, sweetened gelatin product |
| | before | | |
| 02 | During | Carbohydrate energy, fluid | A sports drink with sugar and sodium |
| | | and electrolytes (primarily | is your best option. You can also use |
| | | sodium) | gel or chew products with water. |

Athletic Event Taking Place in the Afternoon/Evening

| | Timing in | | |
|---|---|---|---|
| | relation to | | |
| | athletic | | |
| Occasion | activity | Patterns | Food Suggestions |
| 03 | Within 30 min | Carbohydrate energy, | Lean meat sandwich, low-fat cottage |
| | after | protein, fluid and | cheese and fruit, pretzels and low-fat |
| | | electrolytes (primarily | string cheese, Greek yogurt, or eat |
| | | sodium) | your dinner with a blend of |
| | | | carbohydrate and lean protein in this |
| | | | timeframe |

Break between training sessions

| | | | |
|---|---|---|---|
| 01 | ~15 min | Carbohydrate energy | Juice, sweetened gelatin product, |
| | before | | gummy bears |
| 02 | During | Carbohydrate energy, fluid | A sports drink with sugar and sodium |
| | | and electrolytes (primiarly | is your best option. You can also use |
| | | sodium) | gel or chew products with water. |
| 03 | Within 30 min | Carbohydrate energy, | Milk, Greek yogurt, lean meat |
| | after | protein, fluid and | sandwich, low-fat cottage cheese and |
| | | electrolytes (primarily | fruit, pretzels and low-fat string |
| | | sodium) | cheese, or eat your dinner with a blend |
| | | | of carbohydrate and lean protein in |
| | | | this timeframe |

Individuals may access the system of the present disclosure using a web-based browser or a mobile device application. Thus, one aspect is a system for prompting the user for information that is used to compile the information sought from the individual in the different levels of the system and for assessing the fuel plan and/or adjusting the same. In another aspect, the individual may provide information immediately or soon after the athletic event. In yet another aspect, the individual may provide or compile some or all of the information regarding food/fuel intake and/or energy level in real-time in relation to the athletic event and/or the fuel intake. This may be provided by way of a keystroke or response recorded or sent via a mobile device carried by the person.

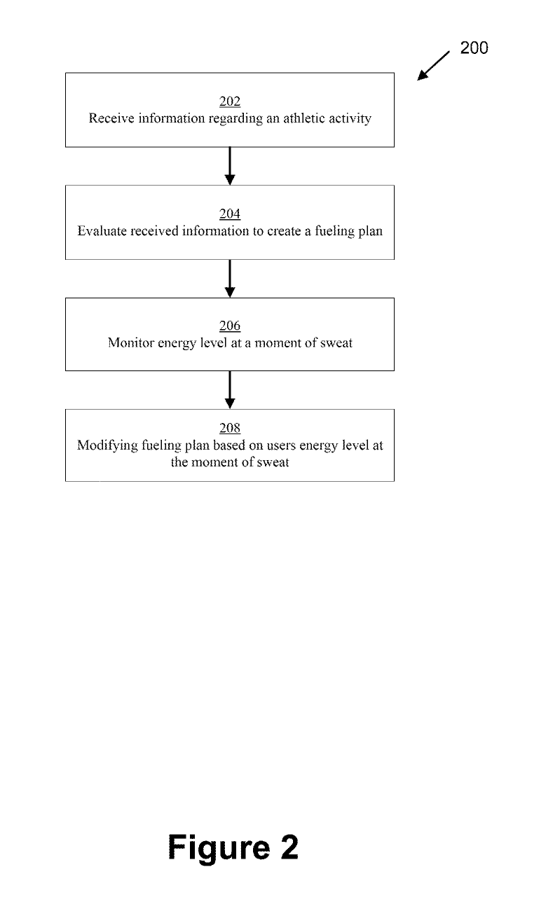

In another embodiment, as shown in FIG. 2, information may be received by fuel plan server 103 in step 202. The information may include information relating to an athletic activity to be performed by a user. The information may include information such as type of athletic event, duration of athletic event, and intensity of athletic activity. The information may also include demographic information regarding the user. In step 204, fuel plan server 103 may evaluate the received information and create a fueling plan for the user. In step 206, the user may be monitored to record their energy level at the moment of sweat. In step 208, the fuel plan server 103 may modify the fueling plan based on the user's energy level at the moment of sweat. Each of these aspects, information of the fuel plan, and any changes or adjustments to the fuel plan, may be sent directly to the individual via a mobile device, such as the individual's cellular phone or to a web-based device worn or used by the individual.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of managing fuel intake of an individual in preparation for, during and subsequent to an athletic event comprising:
a. collecting information from the individual including type of athletic event, duration, and intensity;
b. evaluating the information to create a fueling plan for the individual including appropriate nutrients to consume before, during, and after the athletic event;
c. monitoring the individual's energy level at a moment of sweat; and using the individual's energy level at the moment of sweat to tailor the fueling plan.

2. The method of claim 1 wherein the nutrients comprise carbohydrate energy, fluid, protein and electrolytes.

3. The method of claim 2 wherein the amounts of carbohydrate energy, fluid, protein and electrolytes to achieve enhanced athletic performance in the athletic event are included in the fueling plan.

4. The method of claim 1 wherein the information collected from the individual further includes the time of day that the individual will perform the athletic activity, the type of level of athlete, and the individual's overall objective or goal with respect to the athletic event.

5. The method of claim 1 wherein the method includes at least two integrated levels.

6. The method of claim 5 wherein the first level comprises providing the individual with the carbohydrate energy, fluid, protein and electrolytes needed in preparing for and participating in the athletic event. and the second level comprises providing the individual with specific types and amounts of carbohydrates, proteins, fluid and electrolytes needed in preparing for and participating in the athletic event.

7. A method of enhancing the athletic performance of an individual by training the individual's body to accept fuels at appropriate times comprising:
a. collecting information from the individual relating to the athletic activity including type of athletic event, duration, intensity the time of day that the individual will perform the athletic activity, the type of level of athlete, and the individual's overall objective or goal with respect to the athletic event;
b. evaluating the information to create a fueling plan for the individual including suggested amounts of carbohydrate energy, fluid, protein and electrolytes to consume before, during, and after the athletic event; and
c. monitoring the individual's energy level at a moment of sweat for each day that the athletic participates in the athletic event.

8. The method of claim 1 wherein the athletic event is selected from the group consisting of sprint or high intensity, strength training, team event, endurance, cardio or cross-training, and two-a-day training.

9. The method of claim 2 wherein the fueling plan includes identifying specific foods that relate to the carbohydrate energy, fluid, protein and electrolytes to consume before, after and during the athletic event.

10. The method of claim 2 wherein the fueling plan identifies specific times when the carbohydrate energy, fluid, protein and electrolytes should be consumed by the individual.

11. The method of claim 2 further comprising tracking the number and type of carbohydrate energy, fluid, protein and electrolytes consumed by the individual before, during and after the athletic event.

12. The method of claim 1 wherein the steps are performed using a web-based browser.

13. The method of claim 1 wherein the steps are performed using a mobile device application.

14. The method of claim 1 wherein the fueling plan is provided to the individual in the form of a report.

15. The report of claim 14 including a compilation of all athletic activity of an individual over a set period of time.

16. The method of claim 7 wherein the athletic event is selected from the group consisting of sprint or high intensity, strength training, team event, endurance, cardio or cross-training, and two-a-day training.

17. The method of claim 7 wherein the fueling plan includes identifying specific foods that relate to the carbohydrate energy, fluid, protein and electrolytes to consume before, after and during the athletic event.

18. The method of claim 7 wherein the fueling plan identifies specific times when the carbohydrate energy, fluid, protein and electrolytes should be consumed by the individual.

19. The method of claim 7 further comprising tracking the number and type of carbohydrate energy, fluid, protein and electrolytes consumed by the individual before, during and after the athletic event.

20. The method of claim 7 wherein the steps are performed using a web-based browser.

21. The method of claim 7 wherein the steps are performed using a mobile device application.

22. The method of claim 7 wherein the fueling plan is provided to the individual in the form of a report.

23. The report of claim 22 including a compilation of all athletic activity of an individual over a set period of time.
